(19) United States
(12) Patent Application Publication
(10) Pub. No.: US 2020/0016787 A1
(43) Pub. Date: Jan. 16, 2020

(54) MACHINE TOOL HAVING MACHINING SPACES AND METHOD

(71) Applicant: HOMAG GmbH, Schopfloch (DE)

(72) Inventors: Sven SCHWEIZER, Rosenfeld (DE); Carsten KANITZ, Rottenburg (DE); Stefan FRIESE, Pfalzgrafenweiler (DE); Christian STURM, Nagold (DE); Volker SCHMIEDER, Moessingen (DE)

(21) Appl. No.: 16/336,080

(22) PCT Filed: Sep. 25, 2017
(86) PCT No.: PCT/EP2017/074192

§ 371 Date: Mar. 22, 2019

(30) Foreign Application Priority Data
Sep. 26, 2016 (DE) 10 2016 218 434.2

(51) Int. Cl. B27M 1/08; B27G 21/00; B23Q 11/00; B23Q 11/08

(52) U.S. Cl. CPC B27M 1/08; B27G 21/00; B23Q 2703/02; B23Q 11/08; B23Q 11/0046

(57) ABSTRACT

The invention relates to a machine tool and to a method by means of which workpieces of, for example, wood or wood materials can be machined. Such a machine tool and such a method can be used in the field of furniture production or component in production. A separating element is provided. A first machining region can be at least partly separated from a second machining region by the separating element.

### TECHNICAL FIELD

The present invention relates to a machining device as well as a method with which workpieces of, for example, wood or wood materials can be machined. Such a machining device and such a method can be used in the field of furniture or component manufacturing.

### PRIOR ART

For wood machining devices as an example for machines from the field of furniture or component manufacturing, series are known in which two machining tables are arranged in a relatively limited installation space, with workpieces being able to be machined in an independent operation. Depending on the type of workpiece, different clamping situations may thereby occur.

However, a machining can thereby occur in such a manner that, as a result of the machining on one machining table, a comparatively strong jet of chips or dust hits a workpiece on the other machining table or mechanical components of the other machining table. There is the risk thereby that a workpiece is damaged and/or the function of the respective other machining table becomes impaired.

For example, if workpieces are contaminated or even damaged by chips owing to the described circumstances, this has negative effects since the surfaces of the workpieces have possibly already been finished and a subsequent painting process cannot be easily carried out owing to the contamination or damage. Rather, further post-processing steps are required since otherwise flaws would become visible on the painted surface.

Moreover, constructional measures must be implemented in order to protect the mechanics of the machining tables from flying chips. This leads to partly complex construction effort and corresponding costs.

For example, a machining center according to EP 1 882 570 A1 is known which is directed at the machining of elongated workpieces such as windows, doors, etc. The machining center thereby has table units as well as a traverse having spindle units which are arranged in such a manner that workpieces of the table unit can be machined simultaneously and the transfer from a first table unit to a second table unit is facilitated. For this purpose, the first and second table units are elongated and aligned in their longitudinal extension parallel to the longitudinal extension of an elongated traverse, with at least one of the table units being movable perpendicularly with respect to the traverse. In this manner, a simultaneous machining of workpieces on two table units is possible, by which the machining capacity is increased with relatively little installation space.

Another known document is DE 10 2014 222 422 A1.

To avoid flying chips, different devices in the prior art can be integrated into a machining device. For example, extraction hoods are known which actively extract chips. For example, a corresponding installation space for the extraction hoods is to be provided between guideways of machining units, in order to ensure their operation. It is evident that such types of solutions are contrary to an approach that is in accordance with a compact construction.

Furthermore, chip guide elements are known in the prior art that are arranged on the machining spindle in order to divert the flying chips and, for example, to introduce them into the extraction hood. The chip guide element can be moved together with the spindle. However, this solution has the disadvantage that restrictions owing to different tool diameters have to be taken into account. For example, a chip guide element cannot be used with a tool having a very small or very large diameter. With a tool having a relatively small diameter, there is the danger of a collision with the workpiece. With a tool having a relatively large tool diameter, a corresponding chip guide element would require a relatively large installation space, by which the mobility of the machining spindle is in turn restricted. Moreover, a chip guide element mounted on a machining spindle cannot be used with certain machining aggregates, such as a 5-axis head.

Moreover, it is known to provide fixed separating elements in a machining device. In this manner, it is possible to carry out parallel machining operations in one machine by means of two machining aggregates. However, this construction requires a relatively high space requirement and, owing to the chosen construction, limits the type of workpieces to be machined to the corresponding size.

### SUMMARY OF THE INVENTION

An object of the present invention is to provide a machining device as well as a method with which a high machine performance can be implemented with a compact construction.

The subject matter of claim 1 provides a corresponding machining device. Furthermore, a method according to the invention in accordance with claim 10 is provided. Further preferred embodiments are specified in the dependent claims, with features of the dependent device claims being used within the scope of the method, whilst features of the dependent method claims can refer to a suitability of the device according to claim 1.

Claim 1 provides a machining device having the following features: a first workpiece holding unit for holding a first workpiece, and a second workpiece holding unit for holding a second workpiece, and a separating element. A first machining region can be separated from a second machining region by the separating element, with one of the workpiece holding units being arranged or being able to be arranged (able to be moved there) into each machining region. In particular, one of the workpiece holding units or the workpiece holding units can be moved into each one of the machining regions. Consequently, the separating element can be placed between the first workpiece holding unit and the second workpiece holding unit. Furthermore, it is provided that the separating element is movable in order to change the dimensions of the first and second machining regions.

The separating element consequently allows a first machining region to be separated from a second machining region in such a manner that no chips can move into the respective other machining region during a machining in one of the machining regions.

The separating element can, as described below, be moved independently by means of its own drive.

The first workpiece holding unit and/or the second workpiece holding unit can comprise a tool clamp or a plurality of tool clamps arranged next to one another (in particular in a row). The tool clamp or the tool clamps can be clamping grippers, vacuum clamps or the like.

The workpiece holding units are preferably designed as clamping grippers which are aligned to two sides. Consequently, a workpiece can be reclamped and consequently machined on two longitudinal sides.

In particular, it is thereby provided that the separating element changes the dimensions of the first and second machining region such that when the dimensions of the first machining region are enlarged, the second machining region is reduced, and vice versa.

The machining device according to the invention has the advantage that variable machining regions can be provided. Consequently, a high machine performance and, at the same time, a small installation space can be realized. The separating element allows the machining regions to be separated from one another. Purely by way of example, it can consequently be prevented that chips or the like move from one machining region into the respective other machining region. Since the separating element is moveable, it can be optimally positioned against the background of tools having different diameters. There are no restrictions owing to very small or large tool diameters.

One idea of the present invention is to insert a separating element between the machining aggregates (for example, machining spindles), machining tables or workpieces, with which the size and/or arrangement of machining regions can be variably changed. This separating element (workspace separating unit) can be driven independently of the machining aggregate or the workpiece, and preferably has its own drive.

Moreover, according to an embodiment described later in more detail, the separating element is designed such that chips or dust can be directed in a specific direction (for example, at least partially in a vertical direction downwards and/or in a vertical direction upwards, and/or laterally). There, the chips and dust can then be collected by a funnel or trough, which is preferably connected to an extraction hose.

The workpiece holding units can be formed as clamping devices, suction clamps, machining tables or the like.

According to a preferred embodiment, it is provided that the separating element is attached to a movable unit or formed integrally with it, said movable unit having a drive, in particular a servomotor, for moving the movable unit. Since the movable unit has its own drive, it can be adjusted independently of a further drive of the machining device, such as, for example, a drive for moving a machining aggregate. Consequently, this embodiment can be used particularly flexibly.

It is preferred that the separating element is moveable, in particular pivotable, relative to the movable unit. In this manner, the separating element can be moved to a position in which the machining regions are connected with one another. It is also possible to set the type of separation between the machining regions. For example, a separation which ensures that no chips penetrate into each different machining region during the machining of a specific workpiece is sufficient in certain cases. If a larger or smaller workpiece is subsequently machined, it can be expedient to change the amount of shielding between the first and second machining region.

In one embodiment, it is provided that the separating element is moveable along a linear guide. The guide is particularly aligned in a horizontal direction. Thus, an exact adjustment is ensured. For example, the guide may be a guide rail into which the movable unit engages and/or along which the separating element is movable.

It is further preferred that the separating element is formed plate-shaped and preferably has a contour, in particular grooves, inclined surfaces and/or curved surfaces, for diverting chips, in particular in an at least partially vertical downwardly oriented direction. The plated-shaped design of the separating element ensures a particularly compact design. Moreover, if the separating element is equipped with a contour for diverting chips, these can be guided to an extraction unit in a particularly advantageous manner without the separating element itself having an extraction unit. According to one particularly preferred variant, the “contour” comprises grooves, however, it can also comprise inclined or curved surfaces.

It is preferred that a first extraction unit is provided in the vertical direction beneath the first and/or second workpiece holding unit, with it being preferred that the first extraction unit comprises a funnel for receiving chips. Thus, chips can follow the gravitational force to the first extraction unit. It is thereby provided according to a particularly advantageous combination that the separating element guides the chips in the direction of the first extraction unit.

The machining device can furthermore have at least one lateral extraction unit. This can extract chips in an edge area of one of the machining regions. Preferably, each of the machining regions comprises a lateral extraction unit.

Preferably, a control unit is provided which is configured to move the separating element before, during or after a clamping of the workpiece with the first workpiece holding unit and/or the second workpiece holding unit. The possibility of separating the machining regions is therefore particularly flexible.

The machining device according to the invention preferably comprises a first machining aggregate and a second machining aggregate which are configured for, in particular, machining a workpiece, with it being preferred that the first machining aggregate can be arranged in the first machining region and the second machining aggregate in the second machining region. This consequently allows a temporally at least partially parallel processing of two workpieces.

According to a further embodiment, the first workpiece holding unit is carried by a first movable carrier that is movable along a first guide unit, in particular a rail, and/or the second workpiece holding unit is carried by a second movable carrier that is movable along a second guide unit, in particular a rail.

It is preferred that the first and/or the second guide unit extends transversely, in particular perpendicular to the guide of the separating element. It is further preferred that the first and/or second guide extends in the same or substantially the same direction as the separating element. In this manner, workpieces can be moved in a preferred manner and conveyed to the site of the machining.

Moreover, several separating elements can also be provided in order to separate three or more machining regions. Furthermore, three or more workpiece holding units can be provided which are preferably arranged parallel to one another. According to one preferred variant, the several separating elements can be moved independently from one another in order to specifically change the several machining regions in this manner.

Furthermore, the present invention can relate to a use of the above-described device.

Moreover, the present invention relates to a method. Over the course of the method, a machining device according to one of the above-described aspects can preferably be used. The method thereby comprises the steps:

Holding or clamping at least one workpiece with a first workpiece holding unit or a second workpiece holding unit,

with a first machining region being at least partially separated from a second machining region by a separating element and the at least one workpiece being arranged or becoming arranged in the first or second machining region,

moving the separating element before, during or after the holding/clamping of the at least one workpiece in order to change dimensions of the first and second machining regions,

machining the at least one workpiece.

The advantages already described within the scope of the machining device are also relevant to the method. It is further preferred that the aforementioned method steps are carried out in the aforementioned sequence.

It is preferred that a first workpiece is held by the first workpiece holding unit and a second workpiece is held by the second workpiece holding unit.

It is further preferred that the first workpiece is transferred from the first workpiece holding unit to the second workpiece holding unit after the machining, or the second workpiece is transferred from the second workpiece holding unit to the first workpiece holding unit after the machining. Consequently, the workpiece can be machined on several sides.

The first and/or second workpiece holding unit is preferably realized such that one workpiece can be clamped on two opposite sides. In this case, the workpiece can be reclamped on the other side of the workpiece holding unit following a machining on a longitudinal side.

Consequently, the workpiece can be machined on both longitudinal sides.

It is preferred that the separating element is moved along a linear guide that in particular is aligned in a horizontal direction. Consequently, the separating element can be guided safely and positioned precisely.

It is further preferred that the separating element for separating the first machining region from the second machining region is moved in between them, in particular pivoted. In other words, the separating element is moved from a resting position into a working position. In the working position, a separation between the machining regions is achieved at least partially.

### BRIEF DESCRIPTION OF THE DRAWINGS

FIG. 1 shows a side view of a preferred embodiment of the present invention.

### DETAILED DESCRIPTION OF THE PREFERRED EMBODIMENTS

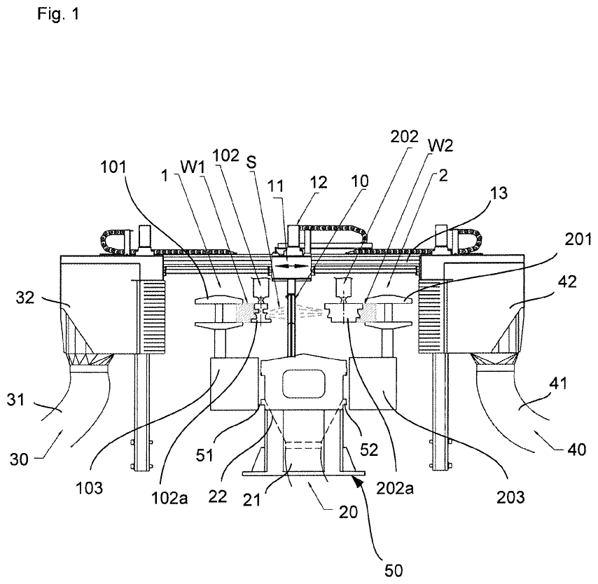

One preferred embodiment of the present invention is described below by means of the enclosed FIG. 1. Further modifications of certain features/components mentioned in this context can each be combined with one another in order to form new embodiments of the invention.

The embodiment described below relates to a machining device which is used in the field of machining workpieces of wood, wood materials or the like. Purely by way of example, the workpieces can be elements for windows, doors, furniture or the like.

The machining device comprises a first machining region 1 as well as a second machining region 2 which, as described below in detail, are variable. Furthermore, a traverse 50 is provided, which extends along the machining device.

In the first machining region 1, a workpiece holding unit 101 is arranged with which a workpiece W1 can be held or clamped in the situation shown in FIG. 1. The first workpiece holding unit 101 is carried by a first movable carrier 103 that is movable along a guide unit 51, in particular a rail, of the traverse 50. The movement of the movable carrier 103, and consequently the first workpiece holding unit 101, occurs here perpendicular to the display plane in FIG. 1.

In the present embodiment, the first workpiece holding unit is formed by a plurality of clamping grippers that are arranged along the movable carrier.

Furthermore, in the first machining region, a first machining spindle 102 (machining aggregate) is arranged with a first machining tool 102a. In the present case, the first machining tool 102a is a milling machining tool, such as a milling cutter or a drill.

In the second machining region 2, there is a second workpiece holding unit 201 with which a second workpiece W2 can be held or clamped in the situation shown in FIG. 1. The second workpiece holding unit 201 is carried by a second movable carrier 203 which is movable along a first guide unit 52, in particular a rail, of a traverse 50. The movement of the moveable carrier 203, and consequently of the second workpiece holding unit 201, occurs perpendicular to the display plane in FIG. 1, in this embodiment example.

In the present embodiment, the second workpiece holding unit is formed by a plurality of clamping grippers that are arranged along the movable carrier.

Furthermore, in the second machining region 2, there is a second machining spindle 202 (machining aggregate) with a second machining tool 202a. In the present case, the second machining tool 202a is also a milling machining tool, such as a milling cutter, a drill, or the like.

According to a modification of the embodiment shown in FIG. 1, at least one of the machining tools can also be a non-milling tool. Purely by way of example, it can be a tool for smoothing the surface, a tool for applying a coating material, or the like.

Although the workpiece holding units 101, 102 in the embodiment shown in FIG. 1 are formed as mechanical clamping units, it is evident that the workpiece holding units can also be formed as vacuum clamps or as a workpiece table.

To change the dimensions of the machining regions 1, 2, a separating element 10 (separating wall) is provided which is attached to a movable unit 11. The movable unit 11 comprises a drive unit 12 and is arranged movably along a guide 13 that is aligned in a horizontal direction. In the embodiment described here, the guide 13 is a guide rail. Since the movable unit 11 with the separating element 10 can be moved along the guide 13, the machining regions 1, 2 can be enlarged or reduced.

Moreover, the separating element 10 is arranged pivotable relative to the movable unit 11, so that the machining regions 1, 2 can be combined into one shared machining region when the separating element 10 is removed or pivoted out (for example, manually or mechanically).

The separating element 10 has a plate-like shape and, according to one modification of the embodiment described here, comprises chip guiding contours (not shown in the present side view) on its surface in order to divert chips S in such a manner that they move into the area of a first extraction unit 20.

The first extraction unit 20 is, when viewed in the vertical direction, arranged beneath the machining regions 1, 2, and comprises a first hose 21 as well as a funnel 22. The funnel 22 is opened in the direction of the machining regions 1, 2 in order to receive falling chips S. The chips S that are received in this manner can then be conveyed with the hose 21 into a receptacle (not shown).

In the embodiment shown here, in addition to the first extraction unit 20 described here, the machining device has a second extraction unit 30 which ensures a lateral extraction. For this, the second extraction unit 30 comprises a second hose 31 as well as a second suction means 32.

A third extraction unit 40 which comprises a third hose 41 as well as a third suction means 42 is provided in the second machining region 2. In the embodiment described here, the second suction means 32 is arranged substantially opposite to the third suction means 42.

An example of the operation of the machining device according to the embodiment of the invention is described below.

A first workpiece W1 is clamped by the workpiece holding unit 101. Simultaneously or subsequently, a second workpiece W2 is clamped by the second workpiece holding unit 201. In the embodiment shown here, the workpieces are arranged substantially parallel to one another, with another arrangement being conceivable in accordance with further variants.

The movable unit 11 is moved along the guide 13 before, during or after the clamping of the workpieces W1, W2 in order to position the separating element 10 corresponding to the dimensions of the workpieces W1, W2 or the machining spindles 102, 202. In the present embodiment example, the second machining tool 202a has, for example, a larger diameter than the first machining tool 102a. Consequently, the movable unit 11 is moved with the separating element 10 in such a manner that the second machining region 2 is larger than the first machining region 1. Consequently, the mobility of the second machining spindle 202 is ensured.

Subsequently, the workpieces W1, W2 can be machined. The chips S that are created during the machining of the first and the second workpiece W1, W2 are thereby diverted by the separating element 10 and guided in the direction of the funnel 22 of the first extraction unit 20. Consequently, the chips S reach the funnel 22 of the first extraction unit 20 and are extracted through the first hose 21.

After the workpieces W1, W2 have been machined, the separating element 10 is, for example, pivoted out of the space of the machining regions 1, 2 and the workpiece W2 is removed from the machining device. Subsequently, the workpiece W1 can be transferred from the first workpiece holding unit 101 to the second workpiece holding unit 201 and the first workpiece holding unit 101 can be loaded with a new workpiece.

Alternatively, it is possible to reclamp the workpiece on the other side of the workpiece holding unit after a machining on a longitudinal side. Thus, the workpiece can be machined on both longitudinal sides. This is made possible in the present embodiment example since the workpiece holding units have clamping grippers that are aligned on two sides, and consequently can accommodate one workpiece from two opposite sides.

In a further method step, the separating element 10 is pivoted back into the region of the machining regions 1, 2, and the movable unit 11 is optionally moved along the guide 13 in order to change the size of the machining regions 1, 2 corresponding to the now present situation.

Alternatively to this, it is possible to remove one of the workpieces W1, W2 or both workpieces W1, W2 from the machining device and to thereby hold the separating element 10 in its position. After the first and/or second workpiece holding device 101, 201 has been loaded again with a workpiece, the position of the separating element 10 can be adjusted.

The movement of the separating element 10 occurs independently of a movement of the first and/or second machining spindle. Consequently, a high degree of flexibility is ensured.

According to a further modification, several separating elements can also be provided in order to separate the two machining regions 1, 2. Whether only one of the separating elements or several separating elements are operated can be decided in accordance with the specific requirement (e.g. workpiece size).

Moreover, multiple separating elements can also be provided in order to separate three or more machining regions. According to one preferred variant, the several separating elements can be moved independently from one another in order to specifically change the several machining regions in this manner.

1. The machining device for machining workpieces, having:
a first workpiece holding unit for holding a first workpiece and a second workpiece holding unit for holding a second workpiece; and
a separating element, a first machining region being able to be at least partially separated from a second machining region by the separating element,
one of the workpiece holding units being arranged or being able to be arranged in each machining region,
wherein the separating element is movable in order to change the dimensions of the first and second machining region.

2. The machining device according to claim 1, wherein the separating element is attached to a movable unit or formed integrally with it, said movable unit having a drive for moving the movable unit.

3. The machining device according to claim 2, wherein the separating element is movable relative to the movable unit.

4. The machining device according to claim 1, wherein the separating element is moveable along a linear guide.

5. The machining device according to claim 1, wherein the separating element is formed plate-shaped.

6. The machining device according to claim 1, wherein a first extraction unit is provided in a vertical direction beneath the first and/or second workpiece holding unit.

7. The machining device according to claim 1, wherein the machining device has at least one lateral extraction unit.

8. The machining device according to claim 1, characterized by a control unit which is configured to move the separating element before, during or after a clamping of a workpiece with the first workpiece holding unit and/or the second workpiece holding unit.

9. The machining device according to claim 1, characterized by a first machining aggregate and a second machining aggregate which are configured for machining.

10. The machining device according to claim 1, wherein the first workpiece holding unit is carried by a first movable carrier which is movable along a first guide unit, in particular a rail, and/or the second workpiece holding unit is carried by a second movable carrier which is movable along a second guide unit.

11. The machining device according to claim 1, wherein the first and/or second workpiece holding unit is realized such that a workpiece can be clamped on two sides of the workpiece holding unit.

12. A method for workpiece machining, preferably using a device according to claim 1, comprising:
holding at least one workpiece with a first workpiece holding unit or a second workpiece holding unit;
a first machining region being at least partially separated from a second machining region by a separating element and the at least one workpiece being arranged or becoming arranged in the first or second machining region;
moving the separating element before, during or after the holding of the at least one workpiece in order to change the dimensions of the first and second machining region; and
machining the at least one workpiece.

13. The method according to claim 12, wherein a first workpiece is held with the first workpiece holding unit, and a second workpiece is held with the second workpiece holding unit.

14. The method according to claim 12, the first workpiece being reclamped on the first workpiece holding unit after the machining of a first longitudinal side, in order to machine a second longitudinal side of the workpiece, and/or the second workpiece being reclamped on the second workpiece holding unit after the machining of a first longitudinal side, in order to machine a second longitudinal side of the second workpiece.

15. The method according to claim 12, the separating element being moved along a linear guide.

16. The method according to claim 12, the separating element for separating the first machining region from the second machining region being moved in between them, in particular pivoted.

17. The machining device according to claim 2, wherein the drive comprises a servomotor.

18. The machining device according to claim 3, wherein the separating element is pivotable relative to the movable unit.

19. The machining device according to claim 4, wherein the linear guide is aligned in a horizontal direction.

20. The machining device according to claim 5, wherein the separating element has a contour comprising inclined surfaces and/or curved surfaces for diverting chips in an at least partially vertical downwardly aligned direction.

21. The machining device according to claim 6, wherein the first extraction unit comprises a funnel for receiving chips.

22. The machining device according to claim 9, wherein the first machining aggregate is able to be arranged in the first machining region and the second machining aggregate in the second machining region.

23. The machining device according to claim 10, wherein at least one of the first guide unit or the second guide unit is a rail.

24. The machining device according to claim 10, wherein the first and/or second guide unit extends transversely to the guide of the separating element.

25. The machining device according to claim 24, wherein the first and/or second guide unit extends perpendicular to the guide of the separating element.

26. The method according to claim 13, wherein the first workpiece and the second workpiece are machined at least partially simultaneously.

27. The method according to claim 15, wherein the linear guide is aligned in a horizontal direction.

28. The method according to claim 16, wherein the separating element is for separating the first machining region from the second machining region being pivoted in between them.
